(19) United States
(12) Patent Application Publication
(10) Pub. No.: US 2016/0070718 A1
(43) Pub. Date: Mar. 10, 2016

(54) APPARATUS AND SYSTEM FOR DATA MIRROR DEVICE

(71) Applicants: INTELLECTUAL DISCOVERY CO., LTD., Seoul (KR); RADIOPULSE INC., Seoul (KR)

(72) Inventors: Dong Hwan LEE, Seoul (KR); Jung Ho KIM, Seoul (KR); Ju Hyung SON, Uiwang-si (KR)

(73) Assignees: RADIOPULSE INC., Seoul (KR); INTELLECTUAL DISCOVERY CO., LTD., Seoul (KR)

(21) Appl. No.: 14/888,221

(22) PCT Filed: Apr. 29, 2014
(86) PCT No.: PCT/KR2014/003771

§ 371 Date: Oct. 30, 2015

(30) Foreign Application Priority Data
Apr. 30, 2013 (KR) 10-2013-0048918
Apr. 30, 2013 (KR) 10-2013-0048919
Apr. 30, 2013 (KR) 10-2013-0048920
Apr. 30, 2013 (KR) 10-2013-0048921

(51) Int. Cl. G06F 17/30; H04L 12/28; H04W 4/00

(52) U.S. Cl. CPC G06F 17/30174; H04W 4/008; H04L 12/2803

(57) ABSTRACT

According to an aspect of the present invention, a data communication method between a battery-operation device and a smart home appliance (HA) in a home area network may be provided. The data communication method comprises: acquiring information of a battery-operation device from data mirroring device by smart HA; transmitting first message with the battery-operation device as final recipient to data mirroring device by smart HA; storing first message and first message identifier corresponding to first message according to type of first message by data mirroring device; initiating operation according to predetermined cycle and transmitting second message to data mirroring device by battery-operation device; inserting first message identifier into response message corresponding to second message and transmitting response message by data mirroring device; and first determination step of analyzing first message identifier and determining whether to make a request for the original first message by battery-operation device.

### BACKGROUND

1. Field

Various exemplary embodiments of the present disclosure broadly relate to a data mirroring technology, and more specifically to a data minoring method and a data mirroring device for efficient communications with battery-powered devices in a home area network in which a home smart grid is implemented.

2. Description of Related Art

Information technology (IT) such as internet and high-speed communications has been advancing. Due to changes of recognition on environmental problems and social interests on eco-environmental technologies, interests on smart grid technologies which are combinations of IT and electric power industry have been increased. The smart grid technology is a technology which implements a stable and highly-efficient intelligent electrical grid through the combination of IT and power electric technologies and can minimize environmental contamination and efficiently use energies. The smart grid network is a next-generation intelligent electrical grid to minimize unnecessary generation of electricity and increase efficiency of electric power usage by bi-directionally exchanging real-time information between an electric power supplier and a consumer through application of IT into conventional power electrical grids.

In the smart grid system, power generation facilities include traditional large-sized power plants such as thermoelectric power plants, hydroelectric power plants, and nuclear power plants, and various new regeneration energy plants such as solar thermal power plants, solar energy plants, and wind power plants. The above large-sized plants transmit generated electricity to power transmission stations through power transmission lines, and the power transmission stations transmit the received electricity to substations which distribute the electricity to final consumers such as home or offices. Also, electricity generated by the large-sized regeneration energy plants can be transmitted to the substations and distributed to respective consumers via the substations.

In the smart grid system, various electrical devices powered by the electricity may be connected to IT communication networks, and control energy supply and demand efficiency based on information exchange through the IT communication networks. The most significant problem of the traditional power grid is that power supply cannot be optimized since the amount of electricity used by the final consumer is not known to the power supplying sites in real time, being caused by unidirectional power supplies and simple metering facilities. However, in the smart grid environment, the amount of energy used can be collected in real-time through smart meters so that control of power generation in respective power plants and estimation of power consumption can be possible. Thus, energy costs can be differentiated according to the control and the estimation so that electricity can be efficiently distributed.

In the home smart grid environment, respective home appliances including smart meters may exchange energy-related information with each other through communications between the respective home appliances. The wired/wireless communication technologies, which can be used for achieving the above purpose, may exist in various forms. However, the most widely used technology is a ZigBee technology. The ZigBee, one of Low Rate Wireless Personal Area Network (LR-WPAN) technologies, is characterized by lower power consumption and low cost, and is implemented as a personal wireless network standard for smart grid and applications of home automation in 2.4 GHz frequency bands.

FIG. 1 illustrates respective layers to which ZigBee and IEEE 802.15.4 standard are applied.

The ZigBee is a communication standard for near-distance networking, and adopts IEEE 802.15.4 standard as its Medium Access Control (MAC) layer and Physical (PHY) layer. Also, its network layer and application layer are defined by a ZigBee Alliance. The ZigBee can provide near-distance communication services within a range of several tens of meters in environments such as home, office, etc. and is one of communication technologies which can realize ubiquitous computing by implementing ‘Internet of Things (IoT)’. Especially, the ZigBee can minimize power consumption so that it can be equipped even in various battery-powered devices such as smart grid devices or home sensors.

Referring to the ZigBee standards, the ZigBee can use frequency bands of 2.4 GHz, 915 MHz, and 868 MHz which are industrial, scientific, and medical (ISM) bands. Also, it can use 16 channels in 2.4 GHz band to provide a transmission speed up to 250 Kbps, 10 channels in 915 MHz band to provide a transmission speed up to 40 Kbps, and one channel in 868 MHz band to provide a transmission speed up to 20 Kbps. Also, it uses a Direct Sequence Spread Spectrum (DSSS) technology in the PHY layer. Thus, through the ZigBee technology, data can be exchanged with 20 to 250 Kbs transmission speeds in several tens of meters distance, and maximum 255 devices can be connected in a single Personal Area Network (PAN), so that a large-sized wireless sensor network can be constructed in an indoor or outdoor environment.

### SUMMARY

Exemplary embodiments have objectives to provide a method of data communication between a battery-powered device and a smart home appliance and devices for the same in a home area network.

Illustrative, non-limiting embodiments may overcome the above disadvantages and other disadvantages not described above. The inventive concept is not necessarily required to overcome any of the disadvantages described above, and the illustrative, non-limiting embodiments may not overcome any of the problems described above. The appended claims should be consulted to ascertain the true scope of the invention.

In order to resolve the above-described problem, a method of data communications between a battery-powered device and a smart home appliance (HA) in a home area network is provided. In the method, the smart HA may acquire information on the battery-powered device from a data mirroring device, the smart HA may transmit a first message designating the battery-powered device as a final recipient to the data mirroring device, the data mirroring device may store the first message and a first message identifier corresponding to the type of the first message, the battery-powered device may transmit a second message to the data mirroring device with a predetermined periodicity, the data mirroring device may transmit the first message identifier to the battery-powered device as included in a response message corresponding to the second message, and the battery-powered device may analyze the first message identifier and determine whether to request an original copy of the first message corresponding to the first message identifier.

Also, the battery-powered device may request a data mirroring service to the data mirroring device, and the battery-powered device may select a device having a storage capacity higher than a predetermined level as the data mirroring device among nearby home area network devices.

Also, the battery-powered device may request the first message to the data mirroring device according to a first determination result, and the data mirroring device receiving the request may determine a method of transferring the first message according to whether an original copy of the first message is stored or not. Also, the data mirroring device may transmit the first message to the battery-powered device according to a second determination result, and the data minoring device may notify a result of the transmission of the first message to the smart HA.

Also, the battery-powered device may request the first message to the data mirroring device according to a first determination result, and the data mirroring device receiving the request may determine a method of transferring the first message according to whether an original copy of the first message is stored or not. Also, the data minoring device may transmit the request to the smart HA according to a second determination result, and the smart HA may transmit the first message to the battery-powered device.

According to exemplary embodiments, it becomes possible to transmit a message to a battery-powered device which operates in sleep mode for most of its operation time.

Especially, according to an exemplary embodiment, in a case that an external home appliance wants to communicate with a battery-powered device after the battery-powered device configures one or more data minoring devices, the data mirroring service can be provided through the one or more data mirroring devices.

### BRIEF DESCRIPTION OF DRAWINGS

Non-limiting and non-exhaustive exemplary embodiments will be described in conjunction with the accompanying drawings. Understanding that these drawings depict only exemplary embodiments and are, therefore, not to be intended to limit its scope, the exemplary embodiments will be described with specificity and detail taken in conjunction with the accompanying drawings, in which:

FIG. 1 illustrates respective layers to which ZigBee and IEEE 802.15.4 standard are applied;

FIG. 2 illustrates a configuration of a home area network system of a smart grid related to an exemplary embodiment;

FIG. 3 is a conceptual block diagram illustrating a home area network device according to an exemplary embodiment;

FIG. 4 illustrates a communication frame structure defined in a ZigBee standard and IEEE 802.15.4 standard which are related to an exemplary embodiment;

FIG. 5 illustrates a topology of a ZigBee wireless related to an exemplary embodiment;

FIG. 6 illustrates relations among a battery-powered device, a data mirroring device, and a smart home appliance which belong to a data mirroring cluster related to an exemplary embodiment; and

FIG. 7 illustrates a communication step between a battery-powered device and a smart home appliance related to an exemplary embodiment.

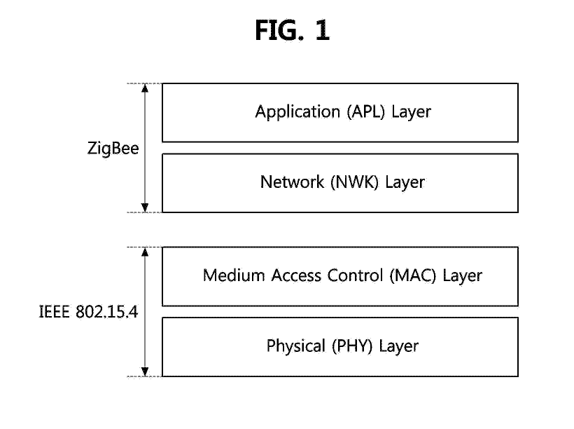

### DETAILED DESCRIPTION OF EXEMPLARY EMBODIMENTS

Since embodiments described in the present specification are intended to clearly describe the spirit of the present invention to those skilled in the art to which the present invention pertains, the present invention is not limited to those embodiments described in the present specification, and it should be understood that the scope of the present invention includes changes or modifications without departing from the spirit of the invention.

The terms and attached drawings used in the present specification are intended to easily describe the present invention and shapes shown in the drawings are exaggerated to help the understanding of the present invention if necessary, and thus the present invention is not limited by the terms used in the present specification and the attached drawings.

In the present specification, detailed descriptions of known configurations or functions related to the present invention which have been deemed to make the gist of the present invention unnecessarily obscure will be omitted below.

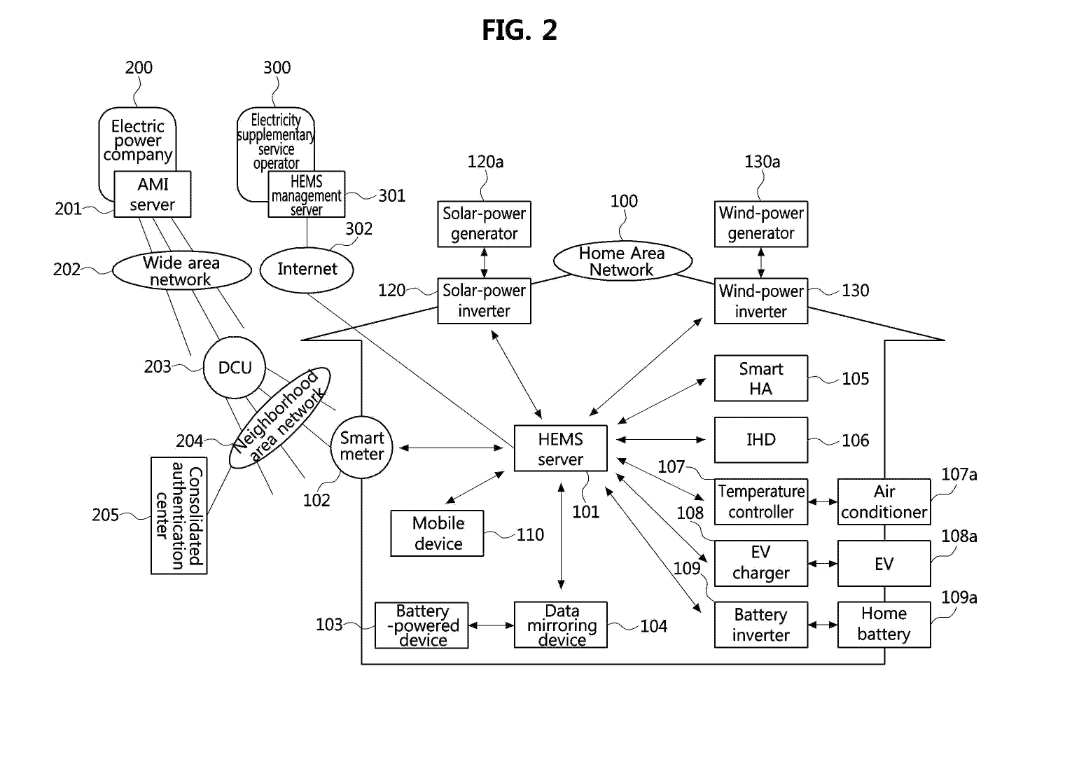

FIG. 2 illustrates a configuration of a home area network system of a smart grid related to an exemplary embodiment.

Referring to FIG. 2, devices in the home area network can include communication modules such as ZigBee, Wi-Fi, Bluetooth, power line communication (PLC), and Ethernet, and perform data communications with each other. The communications inside the home can be performed through the above wired/wireless communications. Also, it is preferable that the respective home area network devices are able to communicate with a HEMS server 101. Also, it is preferable that the respective home area network devices are deployed to be communicable with other home area network devices.

The home area network device may be referred to various devices which need energy control such as a smart home appliance 105, an in-home display 106, a temperature controller 107 connected to and controlling an air conditioner 107a, an electric vehicle (EV) charger 108 configured to charge an EV 108a, a battery inverter 109 controlling charging/discharging of a home battery 109a, a battery-powered device 103 which operates based on a battery, a data minoring device 104 which performs data minoring for the battery-powered device 103, a mobile device 110 of a user, a solar-power inverter 120 converting a direct current generated by a solar-power generator 120a into an alternating current, a wind-power inverted 130 converting a direct current generated by a wind-power generator 130a into an alternating current, etc.

A home energy management system (HEMS) server 101 which is responsible for real-time power management and estimation of demanded power, and a smart meter 102 which meters the amount of power consumption in real time take main roles of the home smart grid.

The HEMS server 101 is a core device of the home energy management system, and performs load controls and energy consumption controls of the home area network devices according to energy-related information received from a HEMS management server 301 administrated by an electric power supplementary service operator 300. The HEMS server 101 may independently exist as a separate physical entity, be embedded in the smart meter 102, or be embedded in the smart appliance 105 such as TV, etc. The HEMS management server 105 may manage the HEMS server 101 of a consumer in a remote site, and configure it.

The smart meter 102 is an electronic metering device having a function of measuring total amount of power consumption of home for respective time bands, and a communication function of transmitting the measured value to an AMI server 201 operated by an electric power company (utility) 200. In comparison to the traditional metering device, the smart meter 102 may have a LCD display, measure power consumption amount in real time, and transmit bi-directionally the measurement result to the electric power company and the consumer via a neighbor area network 204 or a home area network 100. Thus, through the smart meter 102, the electric power company 200 and the consumer respectively may obtain an effect of reducing the costs of manual metering and an effect of reducing consumed energy.

The smart meter installed in office or home may measure the amount of electric power used in the office or home and transmits the measured amount to the AMI server 201. Also, the smart meter may receive a real-time electric charge, a load control message, a notification message, etc. and share the received information with the user or home area network devices. Through this, the user may recognize the currently-used electric power amount or electric charge, and seek for a method for reducing the amount of power consumption or the electric charge.

The Advanced Metering Infrastructure (AMI) system which monitors power consumption rates of respective consumers may be a core infrastructure for the smart grid. The AMI, a system which can collect energy consumption rates in real time, may comprise the smart meter 102 installed in the respective homes and measuring the amount of electric powers used by the respective homes, a data collection unit (DCU) which is a data collecting device collecting data from a plurality of smart meters in the middle, and the AMI server 201 which finally collects the data from a plurality of DUCs 203 through a wide area network 202. Here, the DCU 203 may communicate with nearby smart meters 102 through a neighborhood area network (NAN) which is connected to a consolidated authentication center 205, and communication with the AMI server 50 through the wide area network (WAN). Also, the smart meters may communicate with home appliances in home through a home area network (HAN) 100. The AMI server 201 is a server located in a network of the electric power company 200, which manages the smart meters 102, transmits information real time energy costs to the smart meters 102, and receives information on real time energy consumption rates of consumers from the smart meters 102.

In the home area grid, electricity can be generated by using the solar-power generator 120a or the wind-power generator 103a and supplied to home itself through the solar-power inverter 120 or the wind-power inverter 130. Alternatively, the electricity generated by them may be resold to an external entity (e.g. electric power company).

The in-home display (IHD) 106, as a device displaying a real time energy consumption rate of the home, may display the amount of electric power used, the amount of water used, the amount of gas used, the amount of electric used for respective home appliances, a real-time energy charge, a real-time quantity of generation, a load control message, a notification message from an electric power company, and various other information.

The mobile device 110 is a portable device which can perform wireless communications with other home area network devices, for example, a smart phone or a portable computer.

In a consumer home, the HEMS server 101, the smart meter 102, and home area network devices exchange messages for demand-response (DR) via an application standard protocol referred to as an energy profile. As an example of the energy profile, there is a ZigBee smart energy profile (SEP). The SEP standard is classified into a SEP 1.x version which operates only in the ZigBee communication technology and a SEP 2.x standard which operates in any communication technologies supporting internet protocol (IP). The SEP is standardized by a ZigBee alliance, and can be equipped in respective devices including the smart meter 102 in the home area network. However, since there are variations for respective functions and nations, there may be devices supporting such the variations (i.e. variations of the SEP).

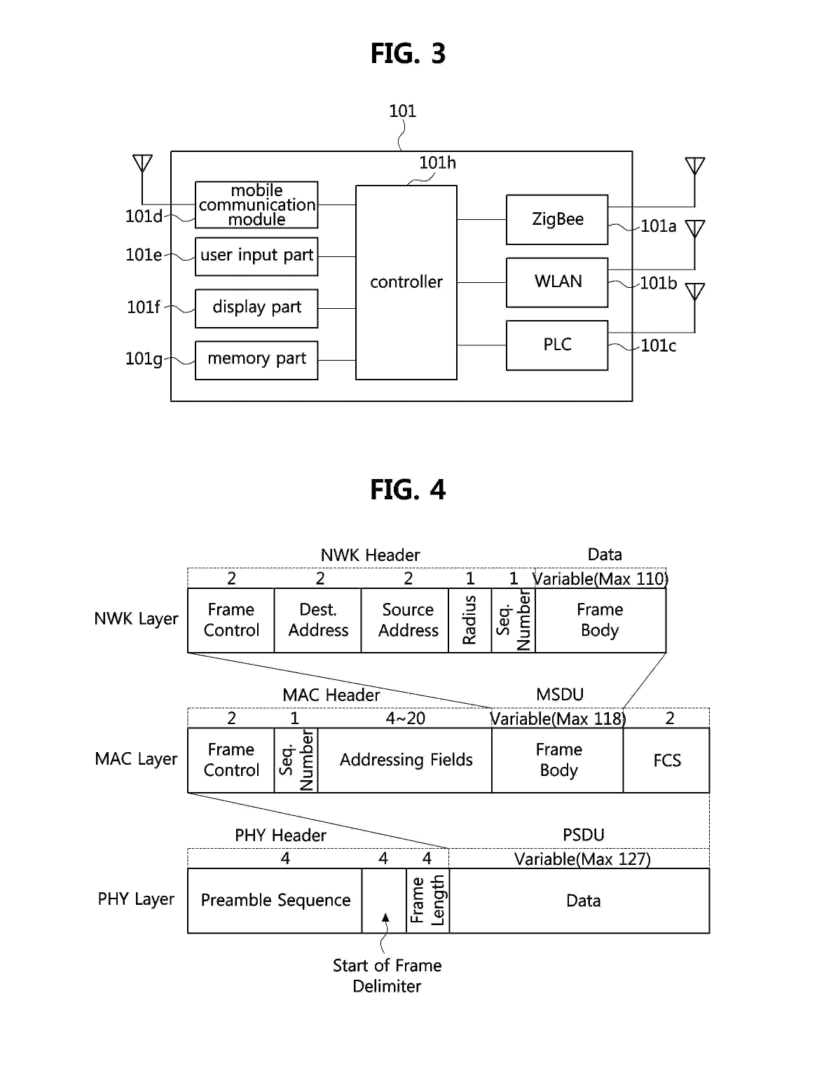

FIG. 3 is a conceptual block diagram illustrating a home area network device according to an exemplary embodiment.

The above device may be one of devices in the home area network 100 illustrated in FIG. 2.

Referring to FIG. 3, the device according to an exemplary embodiment may comprise a communication module for bi-directional communications with other home area network devices, such as a ZigBee 101a, a WLAN 101b, a PLC 101c, or a mobile communication module, a user input part 101e which receives a user input signal, a display part 101f displaying electric power information received from the communication module 101a, 101b, 101c, or 101d or information on the home area network devices, and a controller 101h configured to receive configuration information, the electric power information, or the information on the home area network device through the communication module 101a, 101b, 101c, or 101d, and to control operations of the device including the display part 101f.

The device may comprise a memory part 101g in which control commands or a program code for the device is stored.

Preferably, the controller 101h of the device may control the display part 101f to display the configuration information, the electric power information, or the information on the device in a graphical manner to the user.

The mobile communication module 101d may enable the device to perform data transmission/reception with an external device in a mobile communication network.

The user input part 101e may enable the user to input a command for controlling the device.

The display part 101f may display results of operations of the device and status of the device. Also, the display part 101f may display information provided from an external device.

FIG. 4 illustrates a communication frame structure defined in a ZigBee standard and IEEE 802.15.4 standard which are related to an exemplary embodiment.

The ZigBee supports both of a slotted-mode and a non-slotted-mode. In the slotted-mode, all devices in a PAN perform synchronization by using a beacon message of a PAN coordinator. In the non-slotted mode, a start of a frame is identified by using a preamble signal. Since synchronization signal is shared in the slotted mode, the slotted-mode has an advantage of high network efficiency. However, due to overhead of the synchronization signal, the slotted-mode is not widely used. The above frame structure is defined commonly for the slotted mode-and the non-slotted-mode.

The IEEE 802.15.4 standard defines a PHY layer and a MAC layer, and the ZigBee alliance defines a Network (NWK) layer. In a PHY layer frame, a preamble sequence corresponding to the first four bytes and a start of frame delimiter (SFD) corresponding to one byte subsequent to the preamble sequence indicates a start of the PHY layer frame. The above-described 5 bytes are referred to a synchronization header (SHR). A frame length filed having a length of 1 byte is subsequent to the SHR, and indicates the length of a PHY layer Service Data Unit (PSDU) following the frame length field. The PSDU is a data set including signals of the MAC layer, and the maximum length of the PSDU is 127 bytes.

A MAC layer frame starts with a frame control filed having a length of 2 bytes. Also, a sequence number field having a length of 1 byte and addressing fields having a length of 4 bytes to 20 bytes are subsequent to the frame control field. It depends on the length of the addressing fields whether to use a short address or an IEEE address longer than the short address in a PAN. After then, a frame body comprising data of a NWK layer follows. At the last of the MAC layer frame, there is a frame check sequence (FCS) field for detection of an error in the frame. A data payload is also referred to as a MAC layer Service Data Unit (MSDU). If the length of the PSDU of the PHY layer is 127 bytes at its maximum, the maximum length of the MSDU may be 118 bytes, excluding the MAC header of 7 bytes and the FCS field of 2 bytes.

The essential fields in a NWK header are a frame control filed of 2 bytes, a recipient address filed of 2 bytes, a source address field of 2 bytes, a radius field of 1 byte, and a sequence number field of 1 byte. That is, the essential fields have a length of 8 bytes totally. If the length of the MSDU is 118 bytes at its maximum, the maximum payload which can be used in the NWK layer may be 110 bytes, excluding the NWK header of 8 bytes.

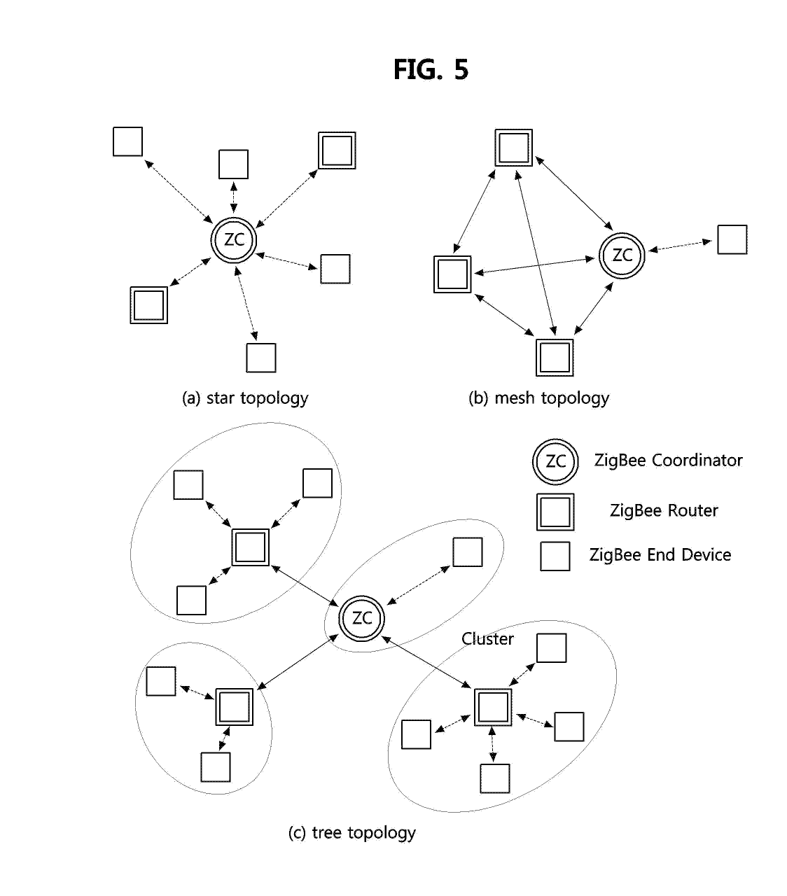

FIG. 5 illustrates a topology of a ZigBee wireless related to an exemplary embodiment.

The ZigBee standard defines three types of network topologies—star, tree, and mesh. Also, the ZigBee standard defines three types of network nodes.

A ‘coordinator’ performs a core role of a network, manages information on all devices connected to a network. Only a Full Function Device (FFD) defined in IEEE 802.15.4 can act as a coordinator.

A ‘router’ does not exist in the star topology. Thus, the router can be applied to only the star topology and the mesh topology. The router performs a role of connecting the coordinator to an end device. Only a FFD device can act as a router. The router can perform a role of an end device at the same time. In this case, the router may be treated as an end device.

An ‘end’ device is an end node of the network which collects sensor data, transmits them, or performs control operations under commands of the coordinator. Usually, an end device may be a Reduce Function Device (RFD) defined in IEEE 802.15.4 which has smaller memory, lower power consumption, and cheaper price as compared to the FFD device.

In the star topology whose implementation is the simplest, the ZigBee coordinator is located in the center of the network, and end devices directly connected to the coordination. In order for an end device to transmit to another end device, the coordinator should relay the data, and thus two links (hops) in which the coordinator participates become necessary. Thus, in a case that adjacent two end devices communicate with each other, inefficiency arises.

In the mesh topology, the coordinator is located in the center of the network, and end devices or routers are connected to the coordinator. Also, a router may be connected to other routers or directly to an end device, and thus the network can grow in size. The difference between the tree topology and the mesh topology is that respective nodes can have multiple parent nodes not a single parent node. Since the mesh topology has a complicated network configuration and each router should have information on all nodes, it has a disadvantage of demanding a large memory. However, even when a single node is lost, a bypass path (i.e. failover path) can be immediately obtained so that higher network reliability can be expected. Also, since it is possible to transmit data through a shortest path without passing the coordinator, overall traffic can be reduced.

In the tree topology, the coordinator is located in the center of the network, and end devices or routers are connected to the coordinator. Also, a router may be connected to other routers or directly to an end device, and thus the network can grow in size. (It is similar to the mesh topology, and the difference between the mesh topology and the tree topology has been already explained above.) Since all data are concentrated on the coordinator in the tree topology, there is a disadvantage that overall traffic increases.

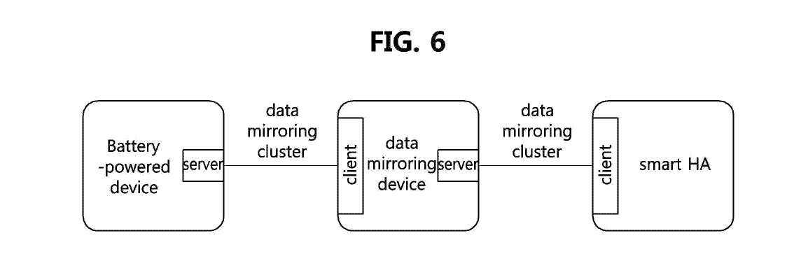

FIG. 6 illustrates relations among a battery-powered device, a data mirroring device, and a smart home appliance which belong to a data mirroring cluster related to an exemplary embodiment.

The battery-powered device may act as a server of a data mirroring cluster, and the data mirroring device may receive information as a client of the server. However, the data mirroring device may act as a server of the data minoring cluster for other external home area network devices, and provide them with mirrored data.

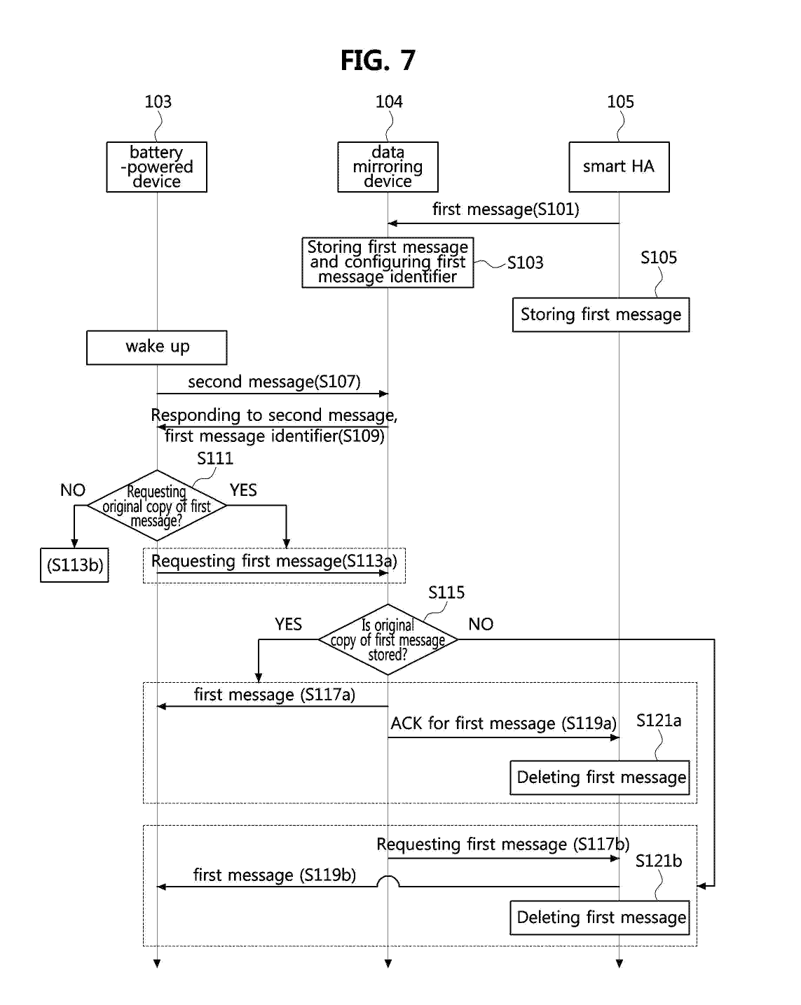

FIG. 7 illustrates a communication step between a battery-powered device and a smart home appliance related to an exemplary embodiment.

The present disclosure provides a data mirroring method and a device for efficiently communicating with battery-powered devices in a home area network (HAN). Especially, in the present disclosure, the battery-powered device may efficiently communicate with other devices in the HAN by utilizing a nearby device as a data mirroring device.

In the HAN (e.g. 100 of FIG. 2), a battery-powered device 103 which operates based on its battery may exist. For example, in European nations, it is regulated that a gas meter operates only based on a small amount of power such as a battery due to a risk of explosion which may be caused by an electric spark at leakage of gas. Also, due to necessities of battery-powered operations, devices which are installed in positions where a wired power cannot be supplied, such as sensors, measuring instruments, controllers, etc., are classified into ‘sleepy’ end nodes in the ZigBee network.

According to the ZigBee standard, all messages toward the battery-powered devices operating as such the sleepy end node may be stored in a parent node of them. However, according to the current ZigBee specification, the parent node is configured to store the messages designating the battery-powered devices under it as recipients for only a short time (e.g. 7.68 seconds). In this case, although the short time does not cause a critical problem to traditional home automation applications, the short time is not enough for the battery-powered devices operating in a home area network of a smart grid environment according to operation characteristics of respective battery-powered devices. For example, in the case of the above-mentioned gas meter, the gas meter may be configured to wake up every 30 minutes to 24 hours and report measurements. Therefore, according to the current ZigBee standard, it may be not possible for an external device to transmit a message to the gas meter.

Thus, the present disclosure proposes a method and a device which enable the battery-powered device to communicate with other devices (e.g. the smart HA 105) in the home area network (e.g. 200 of FIG. 2) by using the nearby data minoring device 104.

For the communications between the battery-powered device 103 and the smart HA 105, the battery-powered device 103 may perform a step of requesting a data minoring service to the data minoring device 104. The battery-powered device 103 may identify nearby devices capable of providing a data minoring service, and then requests the identified device to perform the data minoring service for it. It is preferred that the data minoring device 104 has a stable power supply, enough computation capability, and enough storage for storing messages. Also, it is preferred that the data minoring device 104 can always receive messages without entering into the sleep mode. The data minoring device 104 may provide data minoring services for at least one battery-powered device 103. Similarly, the battery-powered device 103 may be provided with data minoring services by one or more data minoring devices 104.

When the smart HA 105 enters into the home area network, the smart HA 105 may identify that the data minoring device 104 performs the data minoring service for the battery-powered device 103.

After then, once the smart HA 105 generates a message (hereinafter, referred to as a ‘first message’) to be transmitted to the battery-powered device 103, the smart HA 105 may transmit the first message to the data minoring device 104 corresponding to the battery-powered device 103 instead of the battery-powered device 103 (S101). Then, the smart HA 105 may store an original copy of the first message (S105). In this instance, the original copy of the first message may be deleted in the smart HA 105 after predetermined time duration expires.

The data mirroring device 104 having received the first message may store an original copy of the first message, and configure an identifier (hereinafter, referred to as a ‘first message identifier’) corresponding to the type of the first message (S103). Here, the original copy of the first message may be deleted in the data mirroring device 104 after a predetermined time duration expires. Also, the identifier assigned according to the type of the first message may be stored until the battery-powered device 104 which is a final receiver of the first message receives the identifier.

Since the battery-powered device 103 operates based on power supplied by a battery, it may periodically enter into a sleep mode, and minimize consumption of power stored in the battery by turning off or deactivation all communication modules. Then, the battery-powered device may periodically (i.e. with a predetermined periodicity) wake up, and transmit a second message including data accumulated during the sleep mode to the data mirroring device 104 (S107). Even when the data accumulated during the sleep mode do not exist, the battery-powered device 103 may transmit the second message to the data mirroring device 104 in order to identify whether a message toward the battery-powered device 103 is mirrored or not (S107).

The data mirroring device 104 having received the second message may transmit a response message corresponding to the second message. In this case, the first message identifier may be transmitted as included in the second message (S109).

The battery-powered device having received the response message including the first message identifier may determine whether to request an original copy of the first message based on the first message identifier (S111).

When it is determined to request the original copy of the first message in the step S111, the battery-powered device may transmit a first request message (S113).

On the contrary, when it is determined not to request the original copy of the first message in the step S111, the battery-powered device may not transmit any request messages (S114).

After completion of the step S113, the data minoring device 104 having received the first request message may determine to perform one of the following operations according to whether the original copy of the first message is stored or not (S115).

In a case that the data mirroring device 104 has the original copy of the first message, the data mirroring device 104 may transmit the first message to the battery-powered device (S117a). Then, the data minoring device 104 may transmit an acknowledgement (ACK) message confirming that the first message has been transferred to the battery-powered device 103 to the smart HA 105 (S119a). The smart HA 105 having received the ACK message may delete the first message stored in the smart HA 105 (S121a).

In a case that the data minoring device 104 does not have the original copy of the first message, the data minoring device 104 may transfer the first request message to the smart HA 105 (S117b). Then, the smart HA 105 may directly transmit the first message to the battery-powered device 103 (S119b). Then, the smart HA 105 may delete the stored first message (S121b).

While exemplary embodiments have been described above in detail, it should be understood that various modification and changes may be made without departing from the spirit and scope of the inventive concept as defined in the appended claims and their equivalents.

1. A data mirroring device comprising:
a controller controlling operations of the data mirroring device; and
at least one communication module transmitting and receiving data based on control commands of the controller,
wherein the controller transmits information on a battery-powered device to a smart home appliance (HA), receives a first message designating the battery-powered device as a final recipient from the smart HA, stores the first message, stores a first message identifier corresponding to a type of the first message, receives a second message from the battery-powered device with a predetermined periodicity, and transmits the first message identifier as included in a response message corresponding to the second message.

2. The data mirroring device according to claim 1, further comprising being requested to perform a data mirroring service from the batter-powered device.

3. The data mirroring device according to claim 2, further comprising being selected to be a data mirroring device by the battery-powered device according to a level of data storage capacity.

4. The data mirroring device according to claim 1, wherein the battery-powered device requests the first message according to a first determination result, and a method of transferring the first message is determined according to whether an original copy of the first message is stored or not.

5. The data mirroring device according to claim 4, wherein the first message is transmitted to the battery-powered device according to a second determination result, and a result of the transmission of the first message is notified to the smart HA.

6. The data mirroring device according to claim 4, wherein the first message is requested to the smart HA according to a second determination result, and the HA transmits the first message to the battery-powered device.

7. A data minoring system in a home area network comprising:
a battery-powered device; and
a smart home appliance (HA),
wherein the smart HA acquires information on the battery-powered device from a data minoring device, the smart HA transmits a first message designating the battery-powered device as a final recipient to the data minoring device, the data mirroring device stores the first message and a first message identifier corresponding to a type of the first message, the battery-powered device transmits a second message to the data minoring device with a predetermined periodicity, the data minoring device transmits the first message identifier to the battery-powered device as included in a response message corresponding to the second message, and the battery-powered device analyzes the first message identifier and determines whether to request an original copy of the first message corresponding to the first message identifier.

8. The data mirroring system according to claim 7, wherein the battery-powered device requests a data minoring service to the data mirroring device.

9. The data mirroring system according to claim 8, wherein the battery-powered device selects a device having a storage capacity higher than a predetermined level as the data minoring device among nearby home area network devices.

10. The data minoring system according to claim 7, wherein the battery-powered device requests the first message to the data minoring device according to a first determination result, and the data minoring device receiving the request determines a method of transferring the first message according to whether an original copy of the first message is stored or not.

11. The data minoring system according to claim 10, wherein the data minoring device transmits the first message to the battery-powered device according to a second determination result, and the data minoring device notifies a result of the transmission of the first message to the smart HA.

12. The data minoring system according to claim 10, wherein the data minoring device transmits a request on the first message to the smart HA, and the smart HA transmits the first message to the battery-powered device.

13. A battery-powered device comprising:
a controller controlling operations of the battery-powered device; and
at least one communication module transmitting and receiving data based on control commands of the controller,
wherein the controller transmits a second message to a data minoring device with a predetermined periodicity, receives, from the data minoring device, a first message identifier received from an external smart home appliance (HA) as included in a response message corresponding to the second message, and analyzes the first message identifier to determine whether to request an original copy of the first message corresponding to the first message identifier.

14. The battery-powered device according to claim 13, wherein the battery-powered device requests a data mirroring service to the data minoring device.

15. The battery-powered device according to claim 14, wherein the battery-powered device selects a device having a storage capacity higher than a predetermined level as the data minoring device among nearby home area network devices.

16. The battery-powered device according to claim 13, wherein the battery-powered device requests a first message to the data mirroring device according to a first determination result.

17. The battery-powered device according to claim 16, wherein the first message is received from the data minoring device.

18. The battery-powered device according to claim 16, wherein the data minoring device transmit a request on the first message to the smart HA, and the smart HA transmits the first message to the battery-powered device.
